(19) United States
(12) Patent Application Publication
(10) Pub. No.: US 2026/0331722 A1
(43) Pub. Date: Oct. 22, 2026

(54) ELECTRODE ASSEMBLY, SECONDARY BATTERY, AND ELECTRONIC DEVICE

(71) Applicant: Ningde Amperex Technology Limited, Ningde (CN)

(72) Inventor: Mingqi CHEN, Ningde (CN)

(73) Assignee: Ningde Amperex Technology Limited, Ningde (CN)

(21) Appl. No.: 19/706,128

(22) Filed: Jun. 12, 2026

Related U.S. Application Data
(63) Continuation of application No. PCT/CN2024/136476, filed on Dec. 3, 2024.

(30) Foreign Application Priority Data
Dec. 14, 2023 (CN) 202311725896.5

(51) Int. Cl. H01M 50/538; H01M 4/02; H01M 4/133; H01M 4/134; H01M 4/38; H01M 4/587; H01M 4/66; H01M 10/0587; H01M 50/533

(52) U.S. Cl. CPC H01M 50/538; H01M 4/133; H01M 4/134; H01M 4/386; H01M 4/587; H01M 4/661; H01M 10/0587; H01M 50/533; H01M 2004/027

(57) ABSTRACT

An electrode assembly, a secondary battery, and an electronic device. One end of a first current collector in a width direction is provided with a plurality of extension members, a first surface of each extension member is provided with a plurality of protruding portions in a protruding manner, and a second surface of the extension member is provided with a plurality of recessed portions in a recessed manner. The electrode assembly includes adjacent extension members. When viewed along a thickness direction of the electrode assembly, two adjacent extension members at least partially overlap, and at least one protruding portion of one extension member is embedded in a recessed portion of another extension member adjacent thereto.

### CROSS-REFERENCE TO RELATED APPLICATIONS

This application is a continuation application of No. PCT/CN2024/136476, field on Dec. 3, 2024, which claims the benefit of priority of Chinese patent application 202311725896.5, filed on Dec. 14, 2023, the contents of which are incorporated herein by reference in its entirety.

### TECHNICAL FIELD

Some embodiments of the present application relate to the field of electrochemical technology, and in particular, to an electrode assembly, a secondary battery, and an electronic device.

### BACKGROUND

The electrode assembly of a battery is mainly manufactured using a lamination process or a winding process. The winding process has been widely adopted due to its simple operation. For a wound battery, the contact area between the tab and the electrode plate is small, resulting in high internal resistance of the battery and likely heat generation during high-current charging and discharging.

Therefore, wound batteries may adopt a multi-tab structure. The electrode plate with a multi-tab structure includes a metal current collector and an active substance layer disposed on a surface of the current collector. During manufacturing, a blank foil region is reserved at an edge of the electrode plate in the width direction, and the blank foil region is cut to form a plurality of tabs. After winding, the plurality of tabs overlap in the thickness direction of the electrode assembly and are bent after overlapping to connect with an external adapter. However, tabs manufactured in this way have relatively low strength, and during manufacturing process, the tabs are prone to deformation or damage.

### SUMMARY

Some embodiments of the present application aim to provide an electrode assembly and a secondary battery that can reduce the technical problem of tab deformation or damage during battery manufacturing.

To solve the technical problem, these embodiments of the present application adopt the following technical solutions:

In a first aspect, the present application provides an electrode assembly including a first electrode plate, a separator, and a second electrode plate that are stacked and wound. The first electrode plate includes a first current collector and a first active substance layer. In a thickness direction of the first current collector, the first current collector has a first surface and a second surface that are disposed opposite to each other, and the first active substance layer is disposed on the first surface and/or the second surface. One end of the first current collector in a width direction is provided with a plurality of extension members. The first surface of each extension member is provided with a plurality of protruding portions in a protruding manner, and the second surface of the extension member is provided with a plurality of recessed portions in a recessed manner. When viewed along a thickness direction of the electrode assembly, two adjacent extension members at least partially overlap, and at least one protruding portion of one extension member is embedded in a recessed portion of another extension member adjacent thereto.

In the above technical solution, by providing protruding portions on the extension member in a protruding manner and recessed portions in a recessed manner, the strength of the extension member can be improved, and deformation or tearing damage of the extension member can be reduced.

Moreover, at least one protruding portion of one extension member is embedded in a recessed portion of another extension member adjacent thereto. After winding, the protruding portions of the extension member are fittingly engaged with the recessed portions of another extension member, which can increase friction between the extension members, reduce mutual misalignment between the extension members, improve bonding strength between the extension members, and facilitate collective welding of the extension members. At the same time, the embedding provision of the protruding portions and the recessed portions allows the protruding portions to be accommodated in the recessed portions, which can reduce space occupied by the protruding portions, further improve overall strength of the extension members, reduce bending deformation and damage of the extension members, and thereby facilitate electrical connection with an adapter.

In some preferred embodiments, the number of the protruding portions of each extension member is M, and 20≤M≤60. Reducing the number of protruding portions can simplify processing difficulty, while increasing the number of protruding portions can better improve strength. Within the above range, processing difficulty can be simplified while the strength of the extension member is improved. If the number of protruding portions of each extension member is relatively large, friction resistance between the extension members and the extension members becomes too great, leading to cracking when the extension members undergo displacement. Preferably, 33≤M≤40.

In some preferred embodiments, the first electrode plate is a negative electrode plate. The first current collector of the negative electrode plate may be made of copper foil, and the extension member is integrally formed with the first current collector and is also made of copper. Copper has relatively high strength and good pitting performance, helping to stamp the recessed portions and protruding portions in the extension member made of copper, thereby improving the strength of the extension member.

In some preferred embodiments, when viewed along a thickness direction of the extension member, a projected area of each protruding portion on the first surface is S mm², and 0.12≤S≤0.5. This facilitates processing and forming of the protruding portion, reduce space occupied by the protruding portion, and improve the strength of the extension member.

In some preferred embodiments, when viewed along the thickness direction of the extension member, the projected area of each protruding portion on the first surface is S mm², and 0.16≤S≤0.4, so as to further reduce failure probability of the cell after dropping.

In some preferred embodiments, an area of the first surface of the extension member is S₁ mm². In each extension member, a total coverage area of all the protruding portions on the first surface is S₂ mm², and 6% S₁≤S₂≤30% S₁, so as to improve the strength of the extension member. Preferably, 8% S₁≤S₂≤20% S₁.

In some preferred embodiments, when viewed along the thickness direction of the electrode assembly, an overlapping area of two adjacent extension members is S₃ mm², and 80% S₁≤S₃≤100% S₁; at least some of the extension members are located in the overlapping region. A sufficient overlapping area can increase friction between two adjacent extension members, reduce relative movement between the extension members, improve bonding strength between the extension members to facilitate electrical connection with an adapter, and improve stability of the electrical connection. Moreover, at least some of the extension members are located in the overlapping region, which facilitates embedding of the protruding portions of the extension members into the recessed portions of adjacent extension members, and a sufficient overlapping area can further increase the number of embeddings between the protruding portions and the recessed portions, increase friction between the extension members, and improve bonding strength between the extension members.

In some preferred embodiments, along a width direction of the first electrode plate, the plurality of protruding portions are sequentially arranged on the first surface of the extension member to form an arrangement group. The extension member includes a plurality of arrangement groups, and the plurality of arrangement groups are sequentially disposed along a winding direction of the first electrode plate. A spacing between two adjacent arrangement groups is L mm, and 1.5≤L≤3. The provision of a plurality of protruding portions forming arrangement groups facilitates uniform coverage of the protruding portions on the extension member, uniformly disperses stress on the extension member, improves strength at various positions of the extension member, and reduces deformation and damage of the extension member.

In some preferred embodiments, the protruding portions in two adjacent arrangement groups are staggered in the winding direction. This provision allows the extension member to be fully and uniformly covered by the protruding portions, further improving overall strength of the extension member and increasing friction between two adjacent extension members.

In some preferred embodiments, in each arrangement group, the number of the protruding portions is N, and 3≤N≤8, so as to more comprehensively improve strength of various parts of the extension member.

In some preferred embodiments, when viewed along a thickness direction of the extension member, the protruding portion is circular. A circular protruding portion more easily disperses stress on the extension member and can improve tear resistance of the extension member. A radius of the protruding portion is R mm, and 1.5≤R≤2.5. Optionally, when viewed along a thickness direction of the extension member, the protruding portion is at least one of elliptical, square, rhombic, trapezoidal, or triangular.

In some preferred embodiments, the first surface of the extension member includes a protruding region provided with the protruding portions and a flat region not provided with the protruding portions. A protruding height of the protruding portion on the first surface is H₁, and 0.02 mm≤H₁≤1 mm. A thickness of the flat region is H₂, and H₂≤H₁, so as to improve strength of the extension member while reducing space occupied by the extension member.

In a second aspect, the present application further provides a secondary battery including a housing, a first tab, a second tab, and the electrode assembly according to any one of the above embodiments of the first aspect. The electrode assembly is accommodated in the housing. One end of the first tab is electrically connected to the extension members of the first electrode plate inside the housing, and another end extends out of the housing. One end of the second tab is electrically connected to the second electrode plate inside the housing, and another end extends out of the housing.

In a third aspect, the present application further provides an electronic device including the secondary battery according to any one of the above embodiments of the first aspect.

### BRIEF DESCRIPTION OF DRAWINGS

One or more embodiments are illustratively described by corresponding drawings, and these illustrative descriptions do not constitute limitations to some embodiments. Elements with the same reference numerals in the drawings are denoted as similar elements. Unless otherwise stated, the drawings do not constitute scale limitations.

FIG. 1 is a schematic structural view of an electrode assembly according to some embodiments of the present application;

FIG. 2 is a schematic view of a layered structure of a first electrode plate according to some embodiments of the present application;

FIG. 3 is a schematic view of a layered structure of a second electrode plate according to some embodiments of the present application;

FIG. 4 is a schematic view of an unfolded structure of a first electrode plate according to some embodiments of the present application;

FIG. 5 is a schematic view of bending and stacking of extension members according to some embodiments of the present application;

FIG. 6 is a schematic structural view of an extension member according to some embodiments of the present application (showing a first surface);

FIG. 7 is a schematic structural view of an extension member according to some embodiments of the present application (showing a second surface);

FIG. 8 is a schematic structural view of an extension member according to some embodiments of the present application; and

FIG. 9 is a schematic structural view of a secondary battery according to some embodiments of the present application.

### DESCRIPTION OF REFERENCE NUMERALS IN THE DRAWINGS

100. secondary battery;
10. electrode assembly; 10a. first turn; 10b. second turn;
11. first electrode plate; 111. first current collector; 111a. first surface; 111b. second surface; 112. first active substance layer; 1111. extension member; 1112. protruding portion; 1113. recessed portion; 1114. arrangement group;
12. second electrode plate; 121. second current collector; 121a. third surface;
121b. fourth surface; 122. second active substance layer;
13. separator;
20. housing; 21. accommodating cavity;
30. first tab;
40. second tab;
X. first direction; Y. second direction; Z. third direction; and K. fourth direction.

### DETAILED DESCRIPTION

Some embodiments in technical solutions of the present application are described in detail below with reference to the drawings. The following embodiments are only used to more clearly illustrate the technical solutions of the present application, and therefore are only examples and cannot be used to limit the protection scope of the present application.

In the description of these embodiments of the present application, the technical terms “first,” “second,” and the like are only used to distinguish different objects and are not to be understood as indicating or implying relative importance or implicitly indicating the number, specific order, or primary-secondary relationship of the indicated technical features. In the description of these embodiments of the present application, “a plurality of” or “the plurality of” means two or more unless otherwise explicitly specified.

In the description of these embodiments of the present application, the term “and/or” only describes an association relationship of associated objects, indicating that three relationships may exist. For example, A and/or B may indicate that only A exists, both A and B exist, and only B exists. In addition, the character “/” herein generally indicates that the associated objects before and after it are in an “or” relationship.

Reference to “embodiment” herein means that a particular feature, structure, or characteristic described in connection with this embodiment may be included in at least one embodiment of the present application. The appearance of this phrase in various places in the specification does not necessarily refer to the same embodiment, nor is it an independent or alternative embodiment that is mutually exclusive with other embodiments. In addition, technical features involved in different embodiments of the present application described below may be combined with each other as long as they do not conflict with each other.

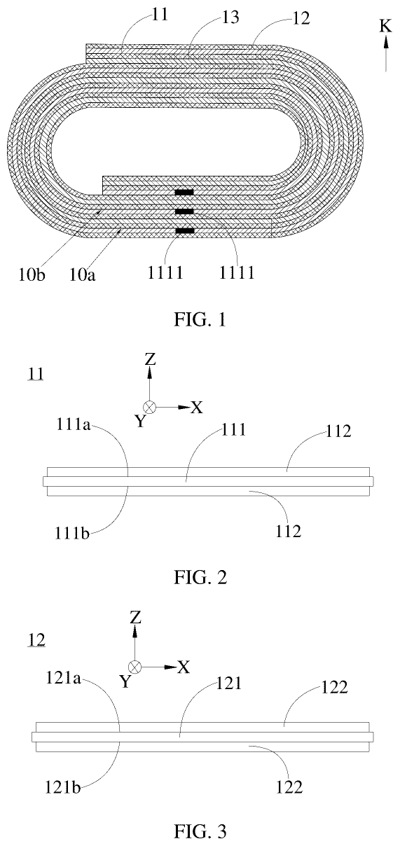

In a first aspect, an embodiment of the present application provides an electrode assembly 10. Referring to FIG. 1, the electrode assembly 10 is formed by stacking and winding a first electrode plate 11, a separator 13, and a second electrode plate 12. The first electrode plate 11 and the second electrode plate 12 have opposite polarities, and the separator 13 is disposed between the first electrode plate 11 and the second electrode plate 12 to separate them.

For the above first electrode plate 11, referring to FIGS. 1 and 2, the first electrode plate 11 includes a first current collector 111 and a first active substance layer 112. Taking the first electrode plate 11 as a negative electrode plate as an example, the first current collector 111 serves as a conductive substrate and may be made of copper foil having an overall flat strip-like structure. In some other embodiments, the first current collector 111 may also be made of nickel foil or polymer-coated copper foil (copper foil with a polymer such as polyethylene, polypropylene, or polyamide disposed on its surface). The first active substance layer 112 may be disposed on at least one surface of the first current collector 111. For example, along a thickness direction (third direction Z) of the first current collector 111, the first current collector 111 includes a first surface 111a and a second surface 111b that are disposed opposite to each other, and the first active substance layer 112 may be disposed on the first surface 111a and/or the second surface 111b. The first active substance layer 112 includes a negative electrode active material, a conductive agent, a binder, and the like. These materials are mixed, stirred well, and applied to the first surface 111a and/or the second surface 111b of the first current collector 111 to obtain the first active substance layer 112. The negative electrode active material may be selected from one or more of graphite, soft carbon, hard carbon, carbon fiber, elemental silicon, silicon oxide compound, or silicon alloy.

For the above second electrode plate 12, referring to FIGS. 1 and 3, the second electrode plate 12 includes a second current collector 121 and a second active substance layer 122. Taking the second electrode plate 12 as a positive electrode plate as an example, the second current collector 121 may be made of aluminum foil having an overall flat strip-like structure. The second active substance layer 122 may be disposed on at least one surface of the second current collector 121. For example, the second current collector 121 includes a third surface 121a and a fourth surface 121b that are disposed opposite to each other along the third direction Z, and the second active substance layer 122 may be disposed on the third surface 121a and/or the fourth surface 121b. In some embodiments of the present application, both the first electrode plate 11 and the second electrode plate 12 adopt a double-sided coating structure, that is, the first surface 111a and the second surface 111b of the first current collector 111 are both provided with the first active substance layer 112, and the third surface 121a and the fourth surface 121b of the second current collector 121 are both provided with the second active substance layer 122.

The second active substance layer 122 includes a positive electrode active material, a conductive agent, a binder, and the like. These materials are mixed, stirred well, and applied to the third surface 121a and/or the fourth surface 121b of the second current collector 121 to obtain the second active substance layer 122. The positive electrode active material may be selected from one or more of lithium nickel cobalt manganese oxide, lithium cobalt oxide, lithium iron phosphate, lithium nickel cobalt manganese oxide, lithium manganese oxide, lithium manganese iron phosphate, or cobalt-free material. It should be noted that the first electrode plate 11 may also be a positive electrode plate, and the second electrode plate 12 may be a negative electrode plate, which is not limited in the present application.

For the above separator 13, the separator 13 is disposed between the first electrode plate 11 and the second electrode plate 12 to insulate and separate the first electrode plate 11 from the second electrode plate 12. The separator 13 may be a PE separator, PP separator, or the like containing ceramic. In some embodiments, surfaces of the separator 13 facing the first electrode plate 11 and the second electrode plate 12 may both be provided with an adhesive coating (not shown in the figure). When the first electrode plate 11, the separator 13, and the second electrode plate 12 are stacked and wound, the separator 13 can be directly bonded between the first electrode plate 11 and the second electrode plate 12, which can improve bonding strength between the first electrode plate 11, the second electrode plate 12, and the separator 13, thereby improving integrity of the electrode assembly 10.

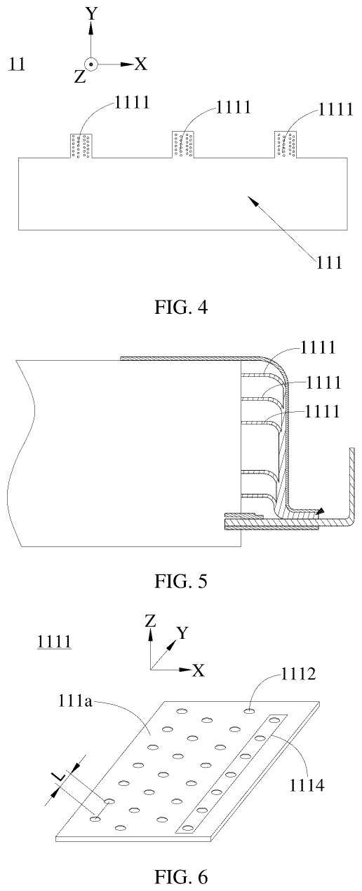

Referring to FIG. 4, at one end of the first current collector 111 in a width direction (second direction Y), the first current collector 111 extends to form a plurality of extension members 1111. The extension members 1111 may be integrally formed with the first current collector 111. For example, a cutting region is reserved at one end of the first current collector 111 in the width direction, and the extension members 1111 may be formed by die-cutting. In some other embodiments, the extension members 1111 may also be provided separately from the first current collector 111, for example, the extension members 1111 are electrically connected to the first current collector 111 by welding, bonding, or clamping.

The extension members 1111 can lead out the polarity of the first electrode plate 11. For example, when the first electrode plate 11 is a negative electrode plate, the extension members 1111 can be conducted with an external circuit to serve as a bridge for conducting the negative electrode of the electrode assembly 10 with the outside. The provision of a plurality of extension members 1111 can improve overcurrent capability of the first electrode plate 11 and facilitate meeting of high-rate charging and discharging requirements. For example, referring to FIG. 5, the plurality of extension members 1111 are bent and stacked into a whole, and an adapter (not shown in the figure) is provided. One end of the adapter is electrically connected to the whole formed by the plurality of extension members 1111, for example, by welding or conductive adhesive bonding with an external adapter for centralized current carrying, and another end of the adapter can be directly conducted with an external circuit.

The inventors of the present application found during implementation of the present application that when the plurality of extension members 1111 are bent and stacked, the extension members 1111 are prone to deformation or even tearing. After electrical connection with the adapter, the electrical connection is unstable or even poor contact occurs.

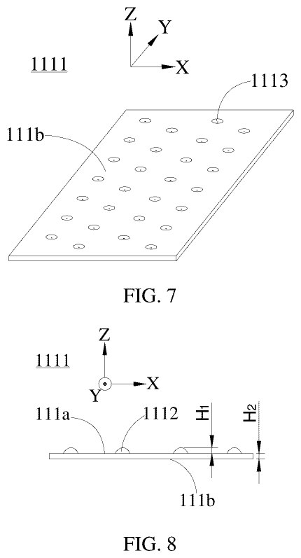

To reduce the above problems, in some embodiments of the present application, further referring to FIGS. 6 and 7, the first surface 111a of the extension member 1111 is provided with a plurality of protruding portions 1112 in a protruding manner, and the second surface 111b of the extension member 1111 is provided with a plurality of recessed portions 1113 in a recessed manner. For example, recessed portions 1113 are directly stamped in the second surface 111b of the extension member 1111, and the recessed portions 1113 protrude from the first surface 111a to form protruding portions 1112. At this time, the protruding portions 1112 and the recessed portions 1113 overlap in a thickness direction of the extension member 1111. Alternatively, recessed portions 1113 are stamped in the second surface 111b, and protruding portions are processed on the first surface 111a. At this time, the protruding portions and the recessed portions 1113 may not overlap in the thickness direction of the extension member 1111.

By providing protruding portions 1112 on the extension member 1111 in a protruding manner and recessed portions 1113 in a recessed manner, the strength of the extension member 1111 can be improved, and deformation or damage of the extension member 1111 can be reduced. It can be understood that the extension member 1111 is obtained by extending from or cutting the first current collector 111, so the first surface 111a of the extension member 1111 is also obtained by extending from or cutting the first surface 111a of the first current collector 111; the second surface 111b is obtained in the similar way.

In some other embodiments, the first surface 111a may also be provided with a plurality of recessed portions 1113 in a recessed manner, and the second surface 111b may also be provided with a plurality of protruding portions 1112 in a protruding manner. Optionally, the first surface 111a is provided with both recessed portions 1113 and protruding portions 1112, and the second surface 111b is provided with both recessed portions 1113 and protruding portions 1112, which can further improve the strength of the extension member 1111 and reduce deformation or damage of the extension member 1111.

Referring to FIG. 1, two adjacent extension members 111 may be extension members 111 disposed on two adjacent turns or extension members 111 spaced apart by one or more turns. The following description takes extension members 111 disposed on two adjacent turns as an example. The first electrode plate 11, the separator 13, and the second electrode plate 12 that are stacked and wound form a wound electrode assembly 10. A plurality of turns include adjacent first turn 10a and second turn 10b, and the first current collector 111 is provided with extension members 1111 on both the first turn 10a and the second turn 10b. The extension members 1111 of each turn may be bent and stacked into a whole to facilitate electrical connection with an adapter. Due to the provision of the protruding portions 1112 and the recessed portions 1113, the strength of the extension members 1111 can be improved, and deformation or tearing damage of the extension members 1111 can be reduced.

When viewed along a thickness direction (fourth direction K in FIG. 1) of the electrode assembly 10, the extension member 1111 of the first turn 10a at least partially overlaps the extension member 1111 of the second turn 10b, and at least one protruding portion 1112 of the extension member 1111 of the first turn 10a is embedded in a recessed portion 1113 of the extension member 1111 of the second turn 10b. After winding, the protruding portions 1112 of the extension member 1111 are fittingly engaged with the recessed portions 1113 of another extension member 1111, which can increase friction between the extension members 1111, reduce mutual misalignment between the extension members 1111, and improve bonding strength between the extension members 1111. Moreover, the embedding provision of the protruding portions 1112 and the recessed portions 1113 allows the protruding portions 1112 to be accommodated in the recessed portions 1113, which can reduce space occupied by the protruding portions 1112, further improve overall strength of the extension members 1111, reduce bending deformation and damage of the extension members 1111, and thereby facilitate electrical connection with an adapter. The number of recessed portions 1113 may be set to be the same as the number of protruding portions 1112, so that all the protruding portions 1112 can be embedded in corresponding recessed portions.

In some embodiments, the first electrode plate 11 is a negative electrode plate, and the second electrode plate 12 is a positive electrode plate. The second current collector 121 may be made of aluminum foil. A plurality of extension members 1111 may also extend in a width direction of the second current collector 121, which is similar to the provision of the first current collector 111, and the extension members 1111 are provided with recessed portions 1113 and protruding portions 1112 to improve strength of the extension members 1111 on the second current collector 121. Since aluminum foil is relatively brittle and difficult to process and form, in some other embodiments, the extension members 1111 on the second current collector 121 may not be provided with recessed portions 1113 and protruding portions 1112. The first current collector 111 may be made of copper foil, nickel foil, or polymer-coated copper foil, which has relatively high strength. For example, the first current collector 111 is made of copper foil, and the extension member 1111 is integrally formed with the first current collector 111 and is also made of copper. Copper has relatively high strength and good pitting performance, helping to stamp the recessed portions 1113 and protruding portions 1112 in the extension member 1111 made of copper, thereby improving the strength of the extension member 1111.

To facilitate processing and forming of the protruding portions 1112, the area of the protruding portions 1112 should not be too small. A sufficient area of the protruding portions 1112 improves the strength of the extension member 1111 and reduces deformation and damage of the extension member 1111. If the protruding portions 1112 are too large, the improvement in strength of the extension member 1111 is not significant, and space occupation is large. In some embodiments of the present application, when viewed along a thickness direction of the extension member 1111, a projected area of each protruding portion 1112 on the first surface 111a of the extension member 1111 is S mm², and 0.12≤S≤0.5, which facilitates processing and forming of the protruding portion 1112, reduce space occupied by the protruding portion 1112, and improve the strength of the extension member 1111. The recessed portions 1113 correspond to the protruding portions 1112, and their corresponding dimensions can refer to the protruding portions 1112.

In some preferred embodiments, when viewed along the thickness direction of the extension member 111, the projected area of each protruding portion 1112 on the first surface 111a is S mm², and 0.16≤S≤0.4, so as to further reduce failure probability of the cell after dropping.

An area of the first surface 111a of the extension member 1111 is S₁ mm², and a total coverage area of all the protruding portions 1112 on the first surface 111a is S₂ mm². In each extension member 1111, the total coverage area of all the protruding portions 1112 on the first surface 111a is S₂ mm², and 6% S₁≤S₂≤30% S₁, preferably 8% S₁≤S₂≤20% S₁.

For example, the area of the first surface 111a of the extension member 1111 may be set to 8 mm² to 200 mm², and the total coverage area of all the protruding portions 1112 on the first surface 111a is 2.4 mm² to 12 mm², so as to improve the strength of the extension member 1111. In each extension member 1111, the number of the protruding portions 1112 is M, and 20≤M≤60. Reducing the number of protruding portions 1112 can simplify processing difficulty, while increasing the number of protruding portions 1112 can better improve strength. Moreover, an excessive number of protruding portions 1112 increases friction between the extension members 1111. However, when the battery is dropped and subjected to a large impact force, its cushioning performance is weak, and excessive friction may cause the extension member 1111 to be displaced due to collision with an adjacent extension member 1111, resulting in deformation, damage, or even tearing of the extension member 1111. If the friction is appropriately reduced, a buffer space can be provided between two adjacent extension members 1111 to ensure relative displacement between the adjacent extension members 1111. Within the above range, processing difficulty can be simplified while the strength of the extension member 1111 is improved, and friction between the extension members 1111 can be balanced, reducing deformation, damage, or tearing of the extension member 1111, reducing production failure risk of the battery, and improving drop and collision resistance of the battery. Preferably, 33≤M≤40.

Referring to FIG. 1, when viewed along a thickness direction of the electrode assembly 10 (fourth direction K), the extension member 1111 of the first turn 10a at least partially overlaps the extension member 1111 of the second turn 10b. For example, an overlapping area of the extension member 1111 of the first turn 10a and the extension member 1111 of the second turn 10b is S₃ mm², and 80% S₁≤S₃≤100% S₁. A sufficient overlapping area can increase friction between two adjacent extension members 1111, reduce relative movement between the extension members 1111, improve bonding strength between the extension members 1111 to facilitate electrical connection with an adapter, and improve stability of the electrical connection. At least some of the extension members 1111 are located in the overlapping region, for example, 60% to 100% of the protruding portions 1112 are located in the overlapping region, which facilitates embedding of the protruding portions 1112 of the extension member 1111 of the first turn 10a into the recessed portions 1113 of the extension member 1111 of the second turn 10b, and a sufficient overlapping area can increase the number of embeddings between the protruding portions 1112 and the recessed portions 1113, increase friction between the extension members 1111, and improve bonding strength between the extension members 1111.

Referring to FIG. 6, along a width direction of the first electrode plate 11 (second direction Y), the plurality of protruding portions 1112 are sequentially arranged on the first surface 111a of the extension member 1111 to form an arrangement group 1114. The extension member 1111 includes a plurality of arrangement groups 1114, and the plurality of arrangement groups 1114 are sequentially disposed along a winding direction of the first electrode plate 11 (first direction X). A spacing between two adjacent arrangement groups 1114 is L mm, and 1.5≤L≤3. The provision of a plurality of protruding portions 1112 forming arrangement groups 1114 facilitates uniform coverage of the protruding portions 1112 on the extension member 1111, uniformly disperses stress on the extension member 1111, improves strength at various positions of the extension member 1111, and reduces deformation and damage of the extension member 1111.

Referring to FIG. 6, the protruding portions 1112 in two adjacent arrangement groups 1114 are staggered along the winding direction of the first electrode plate 11. In one arrangement group 1114, two adjacent extension members 1111 are spaced apart to form a spacing region. When viewed along the winding direction of the first electrode plate 11, the spacing region overlaps at least one protruding portion 1112 in another arrangement group 1114. This provision allows the extension member 1111 to be fully and uniformly covered by the protruding portions 1112, further improving overall strength of the extension member 1111 and increasing friction between two adjacent extension members 1111.

In a single arrangement group 1114, the number of the protruding portions 1112 is N, and 3≤N≤8, which can be set according to the size of the extension member 1111, so as to more comprehensively improve strength of various parts of the extension member 1111.

When viewed along a thickness direction of the extension member 1111, the protruding portion 1112 is circular. A circular protruding portion 1112 more easily disperses stress on the extension member 1111 and can improve tear resistance of the extension member 1111. A radius of the protruding portion 1112 is R mm, and 1.5≤R≤2.5. In some other embodiments, when viewed along a thickness direction of the extension member 1111, the protruding portion 1112 may also be set to elliptical, square, rhombic, trapezoidal, triangular, or polygonal, protruding on the first surface 111a and/or the second surface 111b and capable of being embedded in the recessed portion 1113.

Referring to FIG. 8, the first surface 111a of the extension member 1111 includes a protruding region provided with the protruding portions 1112 and a flat region not provided with the protruding portions 1112. A protruding height of the protruding portion 1112 on the first surface 111a is H₁, and 0.02 mm≤H₁≤1 mm, which can improve strength of the extension member 1111 while facilitating embedding of the protruding portion 1112 into the recessed portion 1113. A thickness of the flat region is H₂, and H₂≤H₁, so as to improve strength of the extension member 1111 while reducing space occupied by the extension member 1111.

In some embodiments of the present application, by providing protruding portions 1112 on the extension member 1111 in a protruding manner and recessed portions 1113 in a recessed manner, the strength of the extension member 1111 can be improved, and deformation or tearing damage of the extension member 1111 can be reduced. Moreover, at least one protruding portion 1112 of the extension member 1111 of the first turn 10a is embedded in a recessed portion 1113 of the extension member 1111 of the second turn 10b. After winding, the protruding portions 1112 of the extension member 1111 are fittingly engaged with the recessed portions 1113 of another extension member 1111, which can increase friction between the extension members 1111, reduce mutual misalignment between the extension members 1111, and improve bonding strength between the extension members 1111. At the same time, the embedding provision of the protruding portions 1112 and the recessed portions 1113 allows the protruding portions 1112 to be accommodated in the recessed portions 1113, which can reduce space occupied by the protruding portions 1112, further improve overall strength of the extension member 1111, reduce bending deformation and damage of the extension member 1111, and thereby facilitate electrical connection with an adapter.

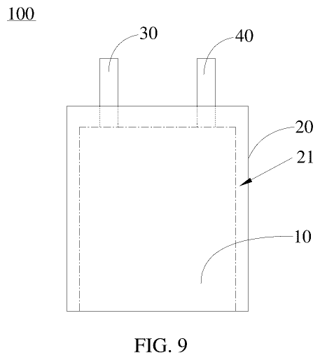

In a second aspect, an embodiment of the present application further provides a secondary battery 100. Referring to FIG. 9, the secondary battery 100 includes a housing 20, a first tab 30, a second tab 40, and the electrode assembly 10 according to any one of the above embodiments of the first aspect.

For the above housing 20, referring to FIG. 9, the housing 20 encloses an accommodating cavity 21, and the accommodating cavity 21 can accommodate the electrode assembly 10 and an electrolyte. In some embodiments of the present application, the housing 20 may be a packaging bag, for example, the housing 20 may be a multi-layer composite film packaging bag including a metal layer. Alternatively, the housing 20 may be directly formed by punching a single metal layer, for example, punching a single steel sheet, to ensure strength of the housing 20.

For the above first tab 30, one end of the first tab 30 is electrically connected to the extension members 1111 of the first electrode plate 11 inside the housing 20. For example, after the extension members 1111 of each turn of the first electrode plate 11 are stacked and crimped, one end of the first tab 30 is electrically connected to the extension members 1111, and another end extends out of the housing 20 to lead out one polarity of the electrode assembly 10, which facilitates conduction with an external circuit. A material of the first tab 30 may be the same as a material of the first current collector 111, for example, copper sheet or nickel sheet.

For the above second tab 40, one end of the second tab 40 is electrically connected to the second electrode plate 12 inside the housing 20. When the second electrode plate 12 is also provided with extension members 1111, one end of the second tab 40 may be directly electrically connected to the extension members 1111 of the second electrode plate 12, and another end directly extends out of the housing 20 to lead out the other polarity of the electrode assembly 10, which facilitates conduction with an external circuit. A material of the second tab 40 may also be the same as a material of the second current collector 121, for example, aluminum sheet. In some other embodiments, copper sheet or nickel sheet may also be used.

In a third aspect, an embodiment of the present application further provides an electronic device including the secondary battery according to any one of the above embodiments of the second aspect. The electronic device in some embodiments of the present application is not particularly limited and may be any electronic device known in the prior art. For example, the electronic device includes but is not limited to a Bluetooth headset, a mobile phone, a tablet, a laptop, an electric toy, an electric tool, an electric bicycle, an electric vehicle, a ship, a spacecraft, and the like. The electric toy may include a fixed or mobile electric toy, such as a game console, an electric car toy, an electric ship toy, an electric airplane toy, and the like. The spacecraft may include an airplane, a rocket, a space shuttle, a spaceship, and the like.

In these embodiments of the present application, a lithium-ion secondary battery is taken as an example for production failure statistics.

### Example 1

(1) Preparation of cathode electrode plate: Lithium cobalt oxide (LiCoO₂) as a cathode active material, conductive carbon black (Super P), and polyvinylidene fluoride (PVDF) were mixed in a weight ratio of 97.5:1.0:1.5, and N-methylpyrrolidone (NMP) was added as a solvent to prepare a slurry with a solid content of 75 wt %, which was stirred well.

Aluminum foil was selected as a cathode current collector, and the slurry was uniformly applied to one surface of the cathode current collector and dried to obtain a cathode electrode plate with a single surface coated with the cathode active substance layer. The above steps were repeated on the other surface of the aluminum foil to obtain a cathode electrode plate with two surfaces coated with the cathode active substance layer.
(2) Preparation of anode electrode plate: Graphite was used as a negative electrode active material, and the negative electrode active material graphite, binder styrene-butadiene rubber (SBR), and thickener sodium carboxymethyl cellulose (CMC) were mixed in a weight ratio of 96:2:2, and deionized water was added as a solvent to prepare a slurry with a solid content of 70 wt %, which was stirred well.

Copper foil was selected as an anode current collector, and the slurry was uniformly applied to one surface of the copper foil with a blank foil region reserved on the surface, and dried to obtain an anode electrode plate with a single surface coated with the anode active substance layer. The above steps were repeated on the other surface of the copper foil to obtain an anode electrode plate with two surfaces coated with the cathode active substance layer. A blank foil region was die-cut to form a plurality of extension members, where a length of the extension member (dimension in a width direction of the anode electrode plate) was 10 mm, a width (dimension in a winding direction of the anode electrode plate) was 7 mm, an area S₁ of the extension member was 70 mm², recessed portions were stamped in one surface of the extension member, and protruding portions were formed on the other surface of the extension member. The number M of protruding portions was 35, a projected area S of each protruding portion on the first surface was 0.1 mm², and a total area S₂ of all protruding portions was 3.5 mm².
(3) Preparation of electrolyte: In a dry argon atmosphere, ethylene carbonate (EC), ethyl methyl carbonate (EMC), and diethyl carbonate (DEC) were first mixed in a mass ratio of EC:EMC:DEC=30:50:20 to form a basic organic solvent, and then lithium salt lithium hexafluorophosphate (LiPF₆) was added to the basic organic solvent and dissolved and mixed well to obtain an electrolyte with a LiPF₆ mass concentration of 12.5%.
(4) Preparation of separator: A polyethylene porous film was used as a substrate layer, and a ceramic layer containing alumina ceramic and PVDF binder was applied to one surface of the base material layer to form a separator (CCS), where a mass percentage of alumina ceramic in the ceramic layer was 95%.
(5) Preparation of electrode assembly: The above cathode electrode plate, separator, and anode electrode plate were stacked and wound. The anode electrode plate extended with extension members in each turn, the extension members of each turn were bent and stacked into a whole, and the protruding portions of the extension members were embedded in the recessed portions of the extension members of an adjacent turn. Nickel sheets and aluminum sheets with a specification of 12 mm×5 mm were selected as tabs. The aluminum tab was welded to the cathode electrode plate (aluminum foil of the cathode electrode plate), and the nickel tab was welded to the extension members of the anode electrode plate to form an electrode assembly for later use.
(6) Assembly of electrode assembly: A punched aluminum-plastic film was placed in an assembly fixture with a pit surface facing upward, the electrode assembly was placed in the pit, and sealing members were provided at the two tabs, and external force was applied to press tightly. Then another punched aluminum-plastic film with a pit surface facing downward covered the electrode assembly, and the peripheries of the two aluminum-plastic films were heat-sealed by hot pressing to obtain an assembled electrode assembly.
(7) Electrolyte injection and encapsulation: An electrolyte was injected into the assembled electrode assembly, followed by vacuum encapsulation, standing, hot pressing formation, shaping, and other processes to obtain a lithium-ion battery.

For relevant parameters of Examples 2 to 16, refer to Table 1 below.

Comparative Example 1 was different from Example 1 in that no protruding portions were provided.

Failure ratio statistics during production: During production, extension members were inspected with a 10× magnifier, and lithium-ion batteries with deformed, damaged, or torn extension members and failure during collective welding of tabs (failure including misalignment of extension members, deformation, damage, tearing, or the like of extension members) were selected. The number was P, and the total production number was 5000, so the production short-circuit failure ratio was P/5000.

TABLE 1

| | Number | Projected | Total area | | | |
|---|---|---|---|---|---|---|
| | of | area of each | of all | Area of | | |
| | protruding | protruding | protruding | extension | | |
| | portions | portion S | portions S₂ | member | | Production |
| | M | (mm²) | (mm²) | S₁ (mm²) | S₂/S₁ | failure ratio |
| Comparative | 0 | 0 | 0 | 70 | 0 | 5.2% |
| Example 1 | | | | | | |
| Example 1 | 35 | 0.1 | 3.5 | 70 | 5% | 0.6% |
| Example 2 | 35 | 0.12 | 4.2 | 70 | 6% | 0.48% |
| Example 3 | 35 | 0.14 | 4.9 | 70 | 7% | 0.46% |
| Example 4 | 35 | 0.15 | 5.25 | 70 | 7.5% | 0.44% |
| Example 5 | 35 | 0.16 | 5.6 | 70 | 8% | 0.4% |
| Example 6 | 35 | 0.18 | 6.3 | 70 | 9% | 0.4% |
| Example 7 | 35 | 0.20 | 7 | 70 | 10% | 0.38% |
| Example 8 | 35 | 0.22 | 7.7 | 70 | 11% | 0.4% |
| Example 9 | 35 | 0.24 | 8.4 | 70 | 12% | 0.4% |
| Example 10 | 35 | 0.26 | 9.1 | 70 | 13% | 0.42% |
| Example 11 | 35 | 0.28 | 9.8 | 70 | 14% | 0.4% |
| Example 12 | 35 | 0.3 | 10.5 | 70 | 15% | 0.42% |
| Example 13 | 35 | 0.4 | 14 | 70 | 20% | 0.42% |
| Example 14 | 35 | 0.5 | 17.5 | 70 | 25% | 0.48% |
| Example 15 | 35 | 0.6 | 21 | 70 | 30% | 0.52% |
| Example 16 | 35 | 0.7 | 24.5 | 70 | 35% | 0.62% |

According to the above Table 1, with reference to Comparative Example 1 and Examples 1 to 16, it can be seen that when protruding portions and recessed portions are provided on the extension member, the production failure ratio of the battery can be effectively reduced. This is because the provision of protruding portions and recessed portions improves the strength of the extension member and enhances tear resistance of the extension member. Therefore, during bending of the extension member, deformation, damage, or tearing of the extension member can be effectively reduced. Moreover, the embedding provision of the protruding portions and the recessed portions increases friction between the extension members, thereby improving integrity of the extension members. When tabs are subjected to collective welding, the welding failure risk is lower.

In Example 1, the area of each protruding portion is relatively small, and its production failure ratio is higher than those in Examples 2 to 15, because the relatively small area of the protruding portion weakens the strength improvement effect on the extension member. In Example 16, the area of each protruding portion is relatively large, and its production failure ratio is also higher than those in Examples 2 to 16, which may be because the strength of the extension member is too great, making the extension member difficult to bend, requiring relatively great force during bending, and resulting in easy deformation of the extension member. Therefore, in some embodiments of the present application, 6% S₁≤S₂≤30% S₁ is selected; in Examples 5 to 13, the production failure ratio is lower, and preferably 8% S₁≤S₂≤20% S₁.

With reference to Examples 2 to 16, when the area of the protruding portion exceeds 0.5 mm², the production failure ratio may increase, which may be because an excessively large protruding portion causes interference with the tab during collective welding of the tab, resulting in insecure welding and welding failure. Moreover, a relatively large protruding portion also affects energy density of the battery. Therefore, in some embodiments of the present application, 0.12≤S≤0.5 is selected.

Further, when 0.16≤S≤0.4, the drop failure rate is lower and the effect is better.

In some embodiments of the present application, a lithium-ion secondary battery is taken as an example for production failure statistics.

Example 17 was different from Example 1 in that in each extension member, the number of protruding portions was 15, the projected area S of each protruding portion was 0.2 mm², and the total area S₂ of all the protruding portions was 3 mm².

For relevant parameters of Example 18 to Example 31, refer to Table 2 below.

Drop test: The lithium-ion battery was charged to 4.45 V at a constant current of 0.2C, and then the lithium-ion battery was charged at a constant voltage of 4.45 V to 0.02C. OCV (open circuit voltage, referring to potential difference between two poles when the battery is not discharged in an open circuit) and IMP (AC internal resistance, internal resistance of the battery under static state) were recorded. At a height of 1.5 m, six faces and four corners of the lithium-ion battery were dropped downward for two rounds each. The standard was no damage or leakage, no deformation of extension members, and no obvious voltage drop (drop of 20 mV).

TABLE 2

| | | Projected | | | | |
|---|---|---|---|---|---|---|
| | | area of | Total area | | | |
| | | each | of all | Area of | | |
| | Number of | protruding | protruding | extension | | |
| | protruding | portion S | portions S₂ | member | | |
| | portions M | (mm²) | (mm²) | S₁ (mm²) | S₂/S₁ | Drop test |
| Comparative | 0 | 0 | 0 | 70 | 0 | 6/10 |
| Example 1 | | | | | | |
| Example 17 | 15 | 0.2 | 3 | 70 | 4.2% | 3/10 |
| Example 18 | 20 | 0.2 | 4 | 70 | 5.7% | 1/10 |
| Example 19 | 25 | 0.2 | 5 | 70 | 7.1% | 1/10 |
| Example 20 | 30 | 0.2 | 6 | 70 | 8.6% | 1/10 |
| Example 21 | 31 | 0.2 | 6.2 | 70 | 8.9% | 1/10 |
| Example 22 | 32 | 0.2 | 6.4 | 70 | 9.1% | 1/10 |
| Example 23 | 33 | 0.2 | 6.6 | 70 | 9.4% | 0/10 |
| Example 24 | 34 | 0.2 | 6.8 | 70 | 9.7% | 0/10 |
| Example 25 | 35 | 0.2 | 7 | 70 | 10% | 0/10 |
| Example 26 | 40 | 0.2 | 8 | 70 | 11.4% | 0/10 |
| Example 27 | 45 | 0.2 | 9 | 70 | 12.9% | 1/10 |
| Example 28 | 50 | 0.2 | 10 | 70 | 14.3% | 1/10 |
| Example 29 | 55 | 0.2 | 11 | 70 | 15.7% | 1/10 |
| Example 30 | 60 | 0.2 | 12 | 70 | 17.1% | 1/10 |
| Example 31 | 65 | 0.2 | 13 | 70 | 18.6% | 2/10 |

According to the above Table 2, with reference to Comparative Example 1 and Comparative Examples 17 to 31, when protruding portions and recessed portions are provided on the extension member, the strength of the extension member can be effectively improved, and the drop failure risk of the extension member can be reduced.

In Example 17, the number of protruding portions is relatively small, and the strength improvement of the extension member is relatively weak, so the drop test failure is high. In Example 31, the number of protruding portions is relatively large, which increases friction between the extension members. However, in a case of a relatively large impact force in the drop test, its cushioning performance is relatively weak, and excessive friction may cause the extension member to be displaced due to collision with an adjacent extension member, resulting in deformation, damage, or even tearing of the extension member. Therefore, with reference to the above Examples 17 to 31, 20≤M≤60 can be selected. With reference to Examples 23 to 26, preferably 33≤M≤40, which can balance friction between the extension members while improving strength, reduce deformation, damage, or tearing of the extension member, reduce production failure risk of the battery, and improve drop and collision resistance of the battery.

Finally, it should be noted that the above embodiments are only used to illustrate the technical solutions of the present application, not to limit them. Under the concept of the present application, technical features in the above embodiments or different embodiments may be combined, steps may be implemented in any order, and there are many other variations of different aspects of the present application as described above, which are not provided in detail for brevity. Although the present application has been described in detail with reference to the foregoing embodiments, those of ordinary skill in the art should understand that they can still modify the technical solutions described in the foregoing embodiments or make equivalent replacements to some of the technical features. These modifications or replacements do not deviate the essence of the corresponding technical solutions from the scope of the technical solutions of some embodiments of the present application.

What is claimed is:

1. An electrode assembly comprising a first electrode plate, a separator, and a second electrode plate that are stacked and wound; wherein the first electrode plate comprises a first current collector and a first active substance layer along a thickness direction of the first current collector; the first current collector has a first surface and a second surface that are disposed opposite to each other, and the first active substance layer is disposed on the first surface and/or the second surface; wherein
one end of the first current collector in a width direction of the first current collector is provided with a plurality of extension members, a first surface of each extension member is provided with a plurality of protruding portions, and a second surface of the each extension member is provided with a plurality of recessed portions; and
when viewed along a thickness direction of the electrode assembly two adjacent extension members at least partially overlap, and at least one protruding portion of one extension member is embedded in a recessed portion of another extension member adjacent thereto.

2. The electrode assembly according to claim 1, wherein the number of the protruding portions of the each extension member is M, and 20≤M≤60.

3. The electrode assembly according to claim 2, wherein 33≤M≤40.

4. The electrode assembly according to claim 1, wherein the first electrode plate is a negative electrode plate.

5. The electrode assembly according to claim 1, wherein when viewed along a thickness direction of the each extension member a projected area of each of the protruding portions on the first surface is S mm², and 0.12≤S≤0.5.

6. The electrode assembly according to claim 5, wherein 0.16≤S≤0.4.

7. The electrode assembly according to claim 1, wherein an area of the first surface of the each extension member is S₁ mm²; and
in the each extension member, a total coverage area of all the protruding portions on the first surface is S₂ mm², and 6% S₁≤S₂≤30% S₁.

8. The electrode assembly according to claim 7, wherein 8% S₁≤S₂≤20% S₁.

9. The electrode assembly according to claim 7, wherein when viewed along the thickness direction of the electrode assembly, an overlapping area of two adjacent extension members is S₃ and 80% S₁≤S₃≤100% S₁.

10. The electrode assembly according to claim 1, wherein along a width direction of the first electrode plate, the plurality of protruding portions are sequentially arranged on the first surface of the each extension member to form an arrangement group; and
the each extension member comprises a plurality of arrangement groups, the plurality of arrangement groups are sequentially disposed along a winding direction of the first electrode plate; a spacing between two adjacent arrangement groups is L mm, and 1.5≤L≤3.

11. The electrode assembly according to claim 10, wherein the protruding portions in two adjacent arrangement groups are staggered in the winding direction.

12. The electrode assembly according to claim 10, wherein in each of the arrangement groups, the number of the protruding portions is N, and 3≤N≤8.

13. The electrode assembly according to claim 1, wherein when viewed along a thickness direction of the extension member, each protruding portion is circular, a radius of the each protruding portion is R mm, and 1.5≤R≤2.5; or
when viewed along a thickness direction of the extension member the each protruding portion is at least one of elliptical, square, rhombic, trapezoidal, or triangular.

14. The electrode assembly according to claim 1, wherein the first surface of the each extension member comprises a protruding region provided with the protruding portions and a flat region not provided with the protruding portions;
a protruding height of the protruding portion on the first surface is H₁, and 0.02 mm≤H₁≤1 mm; and
a thickness of the flat region is H₂, and H₂≤H₁.

15. The electrode assembly according to claim 1, wherein the second electrode plate comprises a negative electrode active material, the negative electrode active material is one or more selected from graphite, soft carbon, hard carbon, carbon fiber, elemental silicon, silicon oxide compound, or silicon alloy.

16. The electrode assembly according to claim 1, wherein the extension members are integrally formed with the first current collector.

17. The electrode assembly according to claim 4, wherein the second current collector is made of aluminum, the second current collector comprises a plurality of second extension members, the second extension members are not provided with the recessed portions.

18. The electrode assembly according to claim 7, wherein 8 mm²≤S₁≤200 mm².

19. A secondary battery comprising a housing, a first tab, a second tab, and the electrode assembly according to claim 1; wherein
the electrode assembly is accommodated in the housing;
one end of the first tab is electrically connected to the extension members of the first electrode plate inside the housing and another end extends out of the housing; and
one end of the second tab is electrically connected to the second electrode plate inside the housing and another end extends out of the housing.

20. An electronic device, comprising the secondary battery according to claim 19.
